(19) United States
(12) Patent Application Publication
(10) Pub. No.: US 2024/0124740 A1
(43) Pub. Date: Apr. 18, 2024

(54) PRINTABLE MEDIA

(71) Applicant: Hewlett-Packard Development Company, L.P., Spring, TX (US)

(72) Inventors: Xiaoqi ZHOU, San Diego, CA (US); Zhang-Lin ZHOU, San Diego, CA (US)

(73) Assignee: Hewlett-Packard Development Company, L.P., Spring, TX (US)

(21) Appl. No.: 18/272,748

(22) PCT Filed: Jan. 22, 2021
(86) PCT No.: PCT/US2021/014613

§ 371 Date: Jul. 17, 2023

(51) Int. Cl. C09D 175/04; C09D 11/322; D06P 1/52; D06P 5/00; D06P 5/30

(52) U.S. Cl. CPC C09D 175/04; C09D 11/322; D06P 1/5285; D06P 5/002; D06P 5/30

(57) ABSTRACT

A printable medium that comprises a base substrate with an image-side and a back-side. An ink-receiving layer comprising water and, at least, two polymeric networks with the first polymeric network being a polyurethane-based polymer and the second polymeric network being a reactive polyaziridine polymer is applied to the image-side of the fabric base substrate. Also described herein are a method for forming the printable medium and a printing method that includes ejecting an ink composition onto the print medium described herein.

### BACKGROUND

Inkjet printing technology has expanded its application to large format high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of medium substrates. Inkjet printing technology has found various applications on different substrates including, for examples, cellulose paper, metal, plastic, fabric, textile and the like. The substrate plays a key role in the overall image quality and permanence of the printed images. Textile printing has various applications including the creation of signs, banners, artwork, apparel, wall coverings, window coverings, upholstery, pillows, blankets, flags, tote bags, etc. It is a growing and evolving area and is becoming a trend in the visual communication market. As the area of textile printing continues to grow and evolve, the demand for new coating compositions and printable mediums increases.

With these printing technologies, it is apparent that the image quality of printed images is strongly dependent on the construction of the recording media used. Pre-treatment compositions or coatings can be applied to various media to improve printing characteristics and attributes of a printed image.

### BRIEF DESCRIPTION OF THE DRAWINGS

The drawings illustrate various examples of the present printable recording media and are part of the specification.

FIG. 1 and FIG. 2 are cross-sectional views of the printable recording media according to some examples of the present disclosure.

FIG. 3 is a flowchart illustrating a method for producing the printable recording media according to one example of the present disclosure.

### DETAILED DESCRIPTION

When printing on media substrates, specifically on fabric substrates, challenges exist due to the specific nature of media and of the fabrics. Indeed, often, some media such as fabric does not accurately receive inks. Some fabrics, for instance, can be highly absorptive, diminishing color characteristics, while some synthetic fabrics can be crystalline, decreasing aqueous ink absorption leading to ink bleed. These characteristics result in the image quality on fabric being relatively low. Additionally, black optical density, color gamut, and sharpness of the printed images are often poor compared to images printed on fabrics or other media types. Durability, such as rubbing resistance, is another concern when printing on fabric, particularly when pigmented inks and ink compositions containing latex are used. To overcome these challenges, a functional coating, such as an image-receiving coating, is applied to the surface of the fabric substrate.

In one example, the present disclosure is drawn to printable medium, comprising a base substrate, with an image-side and a back-side, and a coating layer applied to, at least, the image-side of the base substrate, comprising water and, at least, two polymeric networks with the first polymeric network being a polyurethane-based polymer and the second polymeric network being a reactive polyaziridine polymer

The present disclosure also relates to a method for forming said printable medium and to the printing method using said printable medium. The method for forming a printable medium comprises providing a base substrate, with an image-side and a back-side; applying a coating composition on at least the image-side of the substrate, comprising water and, at least, two polymeric networks with the first polymeric network being a polyurethane-based polymer and the second polymeric network being a reactive polyaziridine polymer. In some examples, the base substrate is a textile base substrate.

The printable medium of the present disclosure has very good printing characteristics and durability performances. As good printing characteristics, it is meant herein good black optical density, good color gamut and sharpness of the printed image. The images printed on the printable medium, which can be a textile printable media, will thus be able to impart excellent image quality: vivid color, such as higher gamut and high color density. High print density and color gamut volume are realized with substantially no visual color-to-color bleed and with good coalescence characteristics. In addition, the images printed on the printable medium of the present disclosure will have excellent durability; specifically, it will have excellent durability under mechanical actions such as rubbing and scratching. The printable medium is thus a printable recording medium (or printable media) that provide printed images that have outstanding print durability and excellent scratch resistance while maintaining good printing image quality (i.e. printing performance). By “scratch resistance”, it is meant herein that the composition is resistant to any modes of scratching which include, scuff and abrasion. By the term “scuff”, it is meant herein damages to a print due to dragging something blunt across it (like brushing fingertips along printed image). Scuffs do not usually remove colorant, but they do tend to change the gloss of the area that was scuffed. By the term “abrasion”, it is meant herein the damage to a print due to wearing, grinding, or rubbing away due to friction. Abrasion is correlated with removal of colorant (i.e. with the OD loss).

In some examples, the printable medium described herein is a coated printable media that can be printed at speeds needed for commercial and other printers such as, for example, HP Latex printers such as 360, 560, 1500, 3200 and 3600 (HP Inc., Palo Alto, CA, USA). The image printed on the printable medium of the present disclosure exhibits excellent printing qualities and durability. By using coating compositions, the printing process is more accurate, and the printed image is more permanent. The present disclosure refers to a printable medium comprising a base substrate and coating compositions applied to said base substrate. The coating compositions, also called treatment compositions, once applied on the base substrate, are solidified, and form thin layers onto the base surface.

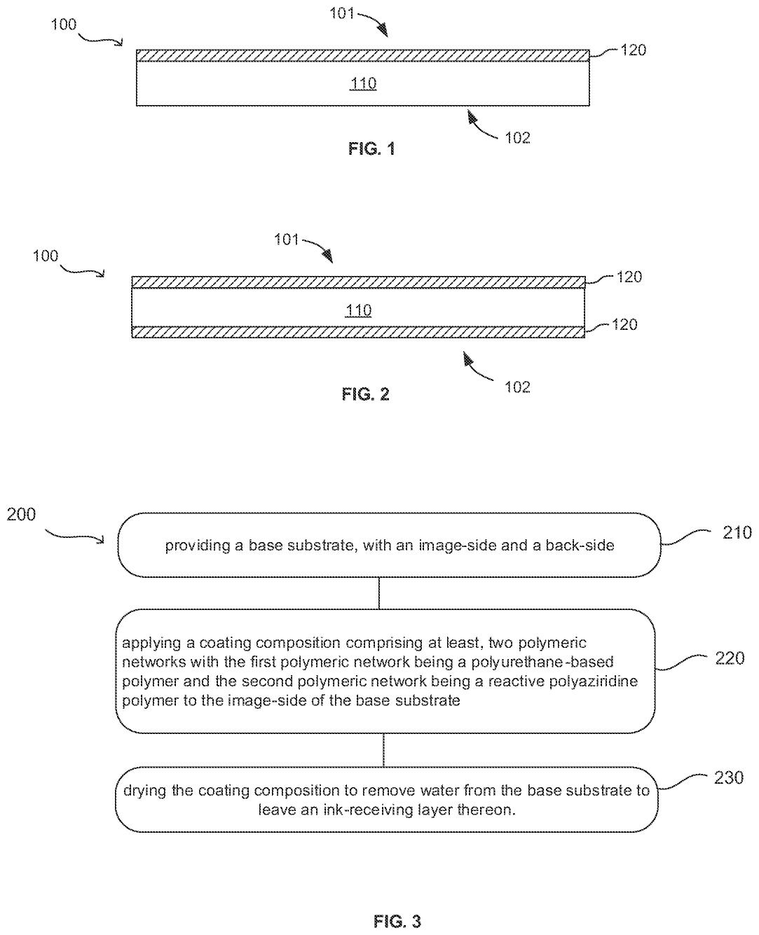

FIG. 1 and FIG. 2 schematically illustrate some examples of the printable medium (100) as described herein. FIG. 3 is a flowchart illustrating an example of a method for producing the printable medium.

As will be appreciated by those skilled in the art, FIG. 1 and FIG. 2 illustrate the relative positioning of the various layers of the printable media without necessarily illustrating the relative thicknesses of the various layers. It is to be understood that the thickness of the various layers is exaggerated for illustrative purposes.

FIG. 1 illustrates the printable recording media (100) as described herein. The printable media (100) encompasses a base substrate or media substrate or bottom supporting substrate (110) and a coating layer (120), also called herein image-receiving layer, that result from the application of a coating composition. The coating composition is applied on, at least, one side of the substrate (110) in order to from a coating layer (120). The image side with the image-receiving layer is considered as the side where the image will be printed. The printable medium (100) has two surfaces: a first surface which might be referred to as the “image-receiving side”, “image surface” or “image side” (101) when coated with the image-receiving layer and the primary layer, and a second surface, the opposite surface, which might be referred to as the “back surface” or “back-side” (102).

In some other examples, such as illustrated in FIG. 2, the printable medium (100) encompasses a base substrate (110) with coating layers (120) that are applied on both sides, on the image (101) and on the back-side (102), of the base substrate (110). In theory, both the image side and the back-side could thus be printed.

An example of a method (200) for forming a printable medium in accordance with the principles described herein, by way of illustration and not limitation, is shown in FIG. 3. As illustrated in FIG. 3, such method (200) encompasses providing (210) a base substrate, with an image-side and a back-side; applying (220) a coating composition as a layer to a media substrate, the coating composition including water and at least, two polymeric networks with the first polymeric network being a polyurethane-based polymer and the second polymeric network being a reactive polyaziridine polymer; and drying (230) the coating composition to remove water from the base substrate to leave an ink-receiving layer thereon (220) in order to obtain the printable medium. When applied on a printable medium, the coating composition, that comprises at least, two polymeric networks with the first polymeric network being a polyurethane-based polymer and the second polymeric network being a reactive polyaziridine polymer, will form an image-receiving coating layer.

The printable medium (100) comprises a base substrate (110) with an image-side and a back-side; a coating layer, or ink-receiving layer (120) comprising water and, at least, two polymeric networks with the first polymeric network being a polyurethane-based polymer and the second polymeric network being a reactive polyaziridine polymer. The printable medium (100) can be a fabric printable medium meaning thus that base substrate (110) is a fabric base substrate. The printable medium can be an inkjet printable medium. In some other examples, the printable medium can be an inkjet printable medium with a textile-based substrate. The printable medium can thus be specifically designed to receive any inkjet printable ink, such as, for example, organic solvent-based inkjet inks or aqueous-based inkjet inks. Examples of inkjet inks that may be deposited, established, or otherwise printed on the printable medium, include pigment-based inkjet inks, dye-based inkjet inks, pigmented latex-based inkjet inks, and UV curable inkjet inks. In one example, the printing ink is a pigmented latex-based inkjet ink.

The Base Substrate (110)

A printable medium (100) of the present disclosure, that can also be called herein printable recording media, is a media that comprises a base substrate (110). The base substrate (110) can also be called bottom supporting substrate. Various types of base supporting substrates can be selected, depending on the specific application of printed materials. The term “base supporting substrate” refers to a solid material such as sheets, or a rolls on which the coating composition can be applied and the image can be formed on top surface of the materials. The word “supporting” also refers to a physical objective of the substrate that is to carry the coatings layer and the image that is going to be printed. The base substrate (110) of the printable medium (100) of the present disclosure can be a fabric-based substrate or can be a cellulose-based substrate

In some examples, the base substrate is cellulose-based substrate. Cellulose-based substrate are supporting substrates that are essentially made from a cellulose (Cellulose-based substrate can also be called “paper” substrate. The cellulose-based substrate contains fibers. In some examples, the cellulose base contains fibers which are sourced from natural wood species only and include fibers from recycling pulps (i.e. wood fiber base) (no polymer fiber). The cellulose-based substrate can contain a synthetic polymeric fiber as a first constituent material and a natural cellulose fiber as a second constituent material, the amount of synthetic polymeric fiber in the fiber composition can be within a range of about 5% to about 80% by weight of total fibers.

The cellulose-based substrate may comprise a PVC-free synthetic polymeric component that is one of synthetic polymeric fiber in a non-woven structure and a synthetic polymeric film. In some examples, the synthetic polymeric fiber can be selected from the group consisting of polyolefins, polyamides, polyesters, polyurethanes, polycarbonates, polyacrylics, a combination of two or more of the fibers, and a mixture of two or more of the fibers. The synthetic polyolefin fiber may include, but is not limited to, polyethylene fiber, polyethylene copolymer fiber, polypropylene fiber, polypropylene copolymer fiber, a combination of two or more of the polyolefin fibers, a combination of any of the polyolefin fibers with another polymeric fiber, mixtures of two or more of the polyolefin fibers, or mixtures of any of the polyolefin fibers with another polymer fiber. In some examples, the fiber composition may include a synthetic cellulosic material including, but not limited to, cellulose diacetate, cellulose triacetate, cellulose propionate, cellulose butyrate, cellulose acetate butyrate and nitrocellulose.

The fiber composition can be used to form a web of the supporting substrate having the non-woven structure, for example, using paper making equipment. The synthetic polymeric fiber may have an average length within a range of about 1 millimeter (mm) to about 3 mm. This length is comparable to the length of natural cellulose fibers. In some examples, the synthetic polymeric fiber has a length greater than 3 mm, provided that the synthetic polymeric fiber does not negatively impact the formation of the layer using the paper making equipment, for example on a screen of a paper mill. In some other examples, the synthetic polymeric fiber has diameter within a range of about 10 micrometers or microns (μm) to about 40 μm with an average length within a range of about 2 mm and about 3 mm.

As indicated above, the cellulose-based substrate may comprise both synthetic fibers and natural fibers. The natural fiber includes natural cellulose fiber from either hardwood species or hardwood species and softwood species. In some examples, a ratio of hardwood fiber to softwood fiber in the cellulose-based substrate can be within a range of about 100:0 to about 50:50. The natural cellulose fiber may be processed into various pulps including, but not limited to, wood-free pulp, such as bleached or unbleached Kraft chemical pulp and bleached or unbleached sulfite chemical pulp; wood-containing pulp, such as one or more of ground wood pulp, thermo-mechanical pulp, and chemo-thermo-mechanical pulp; pulp of non-wood natural fiber, such as one or more of bamboo fiber, bagasse fiber, recycled fiber, cotton fiber; a combination of two or more pulps, or a mixture of two or more of pulps. An amount of synthetic polymeric fiber in the cellulose-based substrate may be within a range of about 10 wt % to about 80 wt % by weight of total fiber. In some examples, the amount of synthetic polymeric fiber by weight of total fiber in the cellulose-based substrate is about 20 wt % to about 70 wt %, or about 30 wt % to about 60 wt %.

The synthetic polymeric component of the cellulose-based substrate (110) can be a PVC-free synthetic polymeric film of high molecular weight. By ‘high molecular weight’, it is meant a weight average molecular weight (Mw) that is greater than 1×10⁴ grams per mole (g/mol or Dalton). The synthetic polymeric film may be made from a non-vinyl chloride polymer including, but not limited to, one or both of homopolymers and copolymers of polyethylene (PE), polypropylene (PP), nylon (polyamides), polystyrene, acrylonitrile butadiene styrene (ABS), polycarbonate, a combination of two or more thereof, or a mixture of two or more thereof. By ‘non-vinyl chloride polymer’ it is meant that there is no polyvinyl chloride (PVC) existing in the synthetic polymeric film, or that the synthetic polymeric film contains no vinyl chloride chain units (i.e., a PVC-free film), since polyvinyl chloride is known to be harmful to the environment, as mentioned above.

The cellulose-based supporting substrate (110) can form a film that can have a thickness within a range of about 40 microns to about 300 microns. The supporting base substrate (110) can form a film that can have a density in a range of about 0.50 grams per cubic centimeter (g/cm3) to about 1.2 g/cm3. In some examples, the cellulose-based supporting substrate is a synthetic polymeric film having a thickness within a range of about 40 microns to about 300 microns and a density within a range of about 0.50 gram per cubic centimeter (g/cm3) to about 1.2 g/cm3, the synthetic polymeric film being one or both of homopolymers and copolymers of high molecular weight selected from the group consisting of polyethylene, polypropylene, polyamide, polystyrene, acrylonitrile butadiene styrene, polycarbonate, a combination of two or more thereof, and a mixture of two or more

In some examples, the base substrate (110) of the printable medium (100) of the present disclosure is a fabric-based substrate. Fabric-based substrate means herein a substrate that is made of fabric.

The term “fabric”, as used herein, is intended to mean a textile, a cloth, a fabric material, fabric clothing, or another fabric product that has mechanical strength and air permeability. The term “fabric structure” is intended to mean a structure having warp and weft that is woven, non-woven, knitted, tufted, crocheted, knotted, or pressed, for example. The terms “warp” and “weft” refers to weaving terms that have their ordinary means in the textile arts. As used herein, warp refers to lengthwise or longitudinal yarns on a loom, while weft refers to crosswise or transverse yarns on a loom. The fabric material includes, but is not limited to, one of woven, non-woven, knitted and tufted; and has a fabric surface that may be one of flat or exhibits pile. The fabric supporting substrate can be a woven, non-woven, knitted or tufted fabric structure. In some examples, the fabric is a woven textile including, but not limited to, satin, poplin, and crepe weave. In some other examples, the fabric-based substrate is a knitted textile including, but not limited to, circular knit, warp knit, and warp knit with a micro denier face.

The fabric-based substrate can be a woven fabric where warp yarns and weft yarns are mutually positioned at an angle of about 90°. This woven fabric includes, but is not limited to, fabric with a plain weave structure, fabric with twill weave structure where the twill weave produces diagonal lines on a face of the fabric, or a satin weave. For example, the direction of the diagonal lines of the twill weave, as viewed along a warp direction, may be up to the right or to the left making a Z or S twill. Compared to plain weave (of the same cloth parameters) twills have longer floats, fewer intersections and a more open construction to help air flow. In contrast to twill weave, the satin weave has a smooth fabric surface free from twill lines by making the distribution of interlacing points between the weft yarns and the warp yarns as random as possible to avoid twill lines. For example, by ‘interlacing points’ it is meant a number of weft yarns float over a single warp yarn, or vice versa, i.e., a number of warp yarns float over a single weft yarn. In some examples of satin weave, the interlacing points repeat by 5, or by 6, or by 7, or by 8.

The fabric-based substrate can also be a knitted fabric with a loop structure including one or both of warp-knit fabric and weft-knit fabric. The weft-knit fabric refers to loops of one row of fabric are formed from the same yarn. The warp-knit fabric refers to every loop in the fabric structure is formed from a separate yarn mainly introduced in a longitudinal fabric direction. In some examples, the fabric of the first layer is a non-woven product, for example a flexible fabric that includes a plurality of fibers or filaments that are one or both of bonded together and interlocked together by a chemical treatment process (e.g., a solvent treatment), a mechanical treatment process (e.g., embossing), a thermal treatment process, or a combination of two or more of these processes.

The fabric-based substrate can comprise one or both of natural fibers and synthetic fibers. Natural fibers that may be used in the fabric of the first layer include, but are not limited to, wool, cotton, silk, linen, jute, flax, or hemp. Additional fibers that may be used include, but are not limited to, rayon fibers, or those of thermoplastic aliphatic fibers derived from renewable resources, including, but not limited to, corn starch, tapioca products, or sugarcanes. These additional fibers are also referred to herein as “natural” fibers for simplicity of discussion. In some examples, the fiber used in the first layer includes a combination of two or more from the above-listed natural fibers, a combination of any of the above-listed natural fibers with another natural fiber or with synthetic fiber, a mixture of two or more from the above-listed natural fibers, or a mixture of any thereof with another natural fiber or with synthetic fiber. The synthetic fiber that may be used in the fabric of the first layer is polymeric fiber including, but not limited to, polyvinyl chloride (PVC)-free fibers made of polyester, polyamide, polyimide, polyacrylic, polypropylene, polyethylene, polyurethane, polystyrene, polyaramid, e.g., Kevlar®, polytetrafluoroethylene, e.g., Teflon® (both trademarks of E. I. du Pont de Nemours and Company), fiberglass, polytrimethylene, polycarbonate, polyester terephthalate, or polybutylene terephthalate. In some examples, the fiber used in the first fabric layer includes a combination of two or more of the fibers, a combination of any of the fibers with another polymeric fiber or with natural fiber, a mixture of two or more of the fibers, or a mixture of any of the fibers with another polymer fiber or with natural fiber. In some examples, the synthetic fiber includes modified fibers. The term ‘modified fibers’ refers to one or both of the polymeric fiber and the fabric as a whole having undergone a chemical or physical process such as, but not limited to, one or more of a copolymerization with monomers of other polymers, a chemical grafting reaction to contact a chemical functional group with one or both the polymeric fiber and a surface of the fabric, a plasma treatment, a solvent treatment, for example acid etching, and a biological treatment, for example an enzyme treatment or antimicrobial treatment to prevent biological degradation. The term “PVC-free” means no polyvinyl chloride (PVC) polymer or vinyl chloride monomer units present in the wall covering or the composite supporting substrate.

The fabric-based substrate can contain both natural fibers and synthetic fibers. In some examples, the amount of synthetic fibers represents from about 20% to about 90% of the total amount of fibers. In some other examples, the amount of natural fibers represents from about 10% to about 80% of the total amount of fibers. In some other examples, the fabric supporting substrate comprises natural fibers and synthetic fibers in a woven structure, the amount of natural fibers is about 10% of a total fiber amount and the amount of synthetic fibers is about 90% of the total fiber amount.

The fabric-based substrate may contain additives including, but not limited to, one or more of colorant (e.g., pigments, dyes, tints), antistatic agents, brightening agents, nucleating agents, antioxidants, UV stabilizers, fillers, flame retardants, and lubricants, for example. The additives are included to improve various properties of the fabric.

The Coating Layer (120)

The printable medium (100) of the present disclosure comprises a base substrate (110) and, at least, a coating layer (120). The coating layer or coating layer composition refers to formulated compositions which are in the viscous liquid state during a processing known as coating process and then dried to form a layer on at least one side of printing media known as image receiving side of the printable medium. Sais coating composition is thus called an image-receiving coating layer.

The printable medium (100) of the present disclosure comprises a base substrate (110) and an image-receiving coating layer (120) applied over, at least, one side of the base substrate. The image-receiving coating layer comprises water and, at least, two polymeric networks with the first polymeric network being a polyurethane-based polymer and the second polymeric network being a reactive polyaziridine polymer. In some examples, the coating layer or image-receiving coating composition (120) can be applied to both the image (101) and the back-side (102), of the base substrate (110). In theory, both the image side and the back-side could thus be printed. The image-receiving coating composition is applied to an “uncoated” media substrate. By “uncoated”, it is meant herein that the media based-substrate (110) has not been treated or coated by any composition and that the image-receiving coating composition is applied directly of the substrate that constitute the media.

The image-receiving coating composition can be applied at a dry coat-weight ranging from about 0.1 to about 40 gsm (gram per square meter) or at a coat-weight ranging or from about 1 to 20 gsm (gram per square meter) or at a coat-weight ranging or from about 2 to 10 gsm (gram per square meter) to a media base substrate (110) in order to form an image-receiving layer (120). In some other examples, the image-receiving coating composition is applied to the base substrate (110) at a thickness ranging from about 1 μm to about 50 μm with a dry coat-weight ranging from about 1 gsm to about 20 gsm to a media base substrate in order to form an image-receiving layer (120).

The coating composition of the printable medium (100) of the present disclosure comprises water and, at least, two polymeric networks. The wording “polymer network” refers herein to a polymer and/or a polymer mixture which has reactive functional groups that can generate crosslinking reaction with the functional groups in the same molecular chains (self-crosslinking), or a polymer and/or a polymer mixture which has reactive functional groups that can generate crosslinking reaction with the functional groups in the other molecular chains (inter-crosslinking).

The first polymeric network is a polyurethane-based polymer, meaning that the first polymeric network is based on polyurethane chemistry. The second polymeric network is a polymeric aziridine crosslinker. In some examples, the coating composition comprises a first polymeric network that is polyurethane particle with both functional reactive groups and non-reactive groups, and the second polymeric network is a polymeric aziridine crosslinker.

The two polymeric networks are substantially reactive with each other at certain condition such as a cure/drying temperature in the range of 50° C. to 120° C. “Reactive” here refers to the fact that polymeric aziridine network can generate reaction such crosslinking action with at least one of polyurethane molecules or both polyurethane molecules that can be found in the first polymeric network. The word “substantially” means that the tendency, or reaction speed, of reaction between two polymer networks can be achieved, i.e., inter molecule cross-linking reaction can generate under certain condition such as a cure/drying temperature of 50-12° C., and practicable time such as the time inside of drying tunnel of 3-15 min. Under these definitions, the two polymer networks are, at least, partially inter-reacting on a polymer functional group scale to each other. A non-reactive polymer can be added into the individual polymer network to modify physical properties of the polymer network. The non-reactive polymer can have an identical or similar monomer structure as corresponding polymer network but minimal or no functional reactive groups to generate self-crosslinking reactive.

In some example, the coating composition of printable medium has two polymeric network wherein the ratio of the first polymeric network to the second polymeric network can be ranging from 10:0.3 ratio to 10:5 ratio. In some example, the coating composition of printable medium has two polymeric network wherein the ratio of the first polymeric network to the second polymeric network can be ranging from 10:0.9 ratio to 10:3 ratio.

In some examples, the coating composition, forming the image-receiving layer, comprises a first crosslinked polymeric network that is a polyurethane based-polymer. By “polyurethane based-polymer” it is mean herein a polymer that comprise polyurethane compound. In some specific examples, the coating composition, forming the image-receiving layer, comprises a first crosslinked polymeric network that is a mixture of self-crosslinkable polyurethane and the non-reactive polyurethane polymers.

The first crosslinked polymeric network can be formed by using self-cross-linked polyurethane polymers. The polyurethane polymers used for building such network can be reactive polyurethane with functional groups. Examples of polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. In some other, the polyurethanes are aromatic polyether polyurethanes, aliphatic polyether polyurethanes, aromatic polyester polyurethanes, and aliphatic polyester polyurethanes.

In some example, the first polymeric network is created by using a self-cross-linked polyurethane polymer. The polyurethane chain can have a trimethyloxysiloxane group and cross-link action can take place by hydrolysis of the function group to form silsesquioxane structure. The polyurethane chain can also have an acrylic function group, and the cross-link structure can be formed by nucleophilic addition to acrylate group through acetoacetoxy functionality.

In some other example, the first polymeric network is created by using vinyl-urethane hybrid copolymer or acrylic-urethane hybrid polymer. In yet some other examples, the first polymeric network includes an aliphatic polyurethane-acrylic hybrid polymer.

The polyurethane polymer can be formed by reacting an isocyanate with a polyol.

Exemplary isocyanates used to form the polyurethane polymer can include toluene-diisocyanate, 1,6-hexamethylenediisocyanate, diphenyl-methanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, and combinations thereof. Commercially available isocyanates can include Rhodocoat® WT 2102 (available from Rhodia AG, Germany), Basonat® LR 8878 (available from BASF Corporation, N. America), Desmodur® DA, and Bayhydur® 3100 (Desmodur® and Bayhydur® are available from Bayer AG, Germany). In some examples, the isocyanate can be protected from water. Exemplary polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclo-hexane-dimethanol; 1,2,3-propanetriol; 2-ethyl-2-hydroxymethyl-1,3-propanediol; and combinations thereof.

The self-cross-linked polyurethane is formed by reacting an isocyanate with a polyol, both isocyanates and polyols have average less than three end functional groups per molecule so that the polymeric network is based on a liner polymeric chain structure. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Exemplary polyisocyanates can include diisocyanate monomers and oligomers. In one example, the polyurethane prepolymer can be prepared with a NCO/OH ratio from about 1.2 to about 2.2. In another example, the polyurethane prepolymer can be prepared with a NCO/OH ratio from about 1.4 to about 2.0. In yet another example, the polyurethane prepolymer can be prepared using an NCO/OH ratio from about 1.6 to about 1.8.

The polyurethane chain can have a trimethyloxysiloxane group and cross-link action can take place by hydrolysis of the function group to form silsesquioxane structure. The polyurethane chain can also have an acrylic function group, and the cross-link structure can be formed by nucleophilic addition to acrylate group through aceto-acetoxy functionality. In some other examples, the first crosslinked polymeric network is formed by using vinyl-urethane hybrid copolymers or acrylic-urethane hybrid polymers. In yet some other examples, the polymeric network includes an aliphatic polyurethane-acrylic hybrid polymer. Representative commercially available examples of the chemicals which can form a polymeric network include, but are not limited to, NeoPac® R-9000, R-9699 and R-9030 (from Zeneca Resins), Sancure® AU4010 (from Lubrizol) and Hybridur® 570 (from Air Products).

In one example, the weight average molecular weight (Mw) of the polyurethane polymer used in the first crosslinked polymer can range from about 20,000 Dalton to about 200,000 Dalton as measured by gel permeation chromatography. In another example, the weight average molecular weight of the polyurethane polymer can range from about 40,000 Dalton to about 180,000 Dalton as measured by gel permeation chromatography. In yet another example, the weight average molecular weight (Mw) of the polyurethane polymer can range from about 60,000 Dalton to about 140,000 Dalton as measured by gel permeation chromatography.

Exemplary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; and combinations thereof. (These polyurethanes are available from Alberdingk Boley Inc., North Carolina, USA).

The first polymeric network can include a polymeric core that is, at least, one polyurethane. The polyurethanes include aliphatic as well as aromatic polyurethanes. The polyurethane is typically the reaction products of the following components: a polyisocyanate having at least two isocyanate functionalities (—NCO) per molecule with, at least, one isocyanate reactive group such as a polyol having at least two hydroxy groups or an amine. Suitable polyisocyanates include diisocyanate monomers, and oligomers. Examples of polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. In some other, the polyurethanes are aromatic polyether polyurethanes, aliphatic polyether polyurethanes, aromatic polyester polyurethanes, and aliphatic polyester polyurethanes. Representative commercially available examples of polyurethanes include Sancure® 2710 and/or Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517®, Sancure® 1591, Sancure® 2255, Sancure® 2260, Sancure® 2310, Sancure® 2725, and Sancure® 2016 (all commercially available from Lubrizol Inc.).

Other examples of commercially-available polyurethanes can include NeoPac® R-9000, R-9699, and R-9030 (available from Zeneca Resins, Ohio), Printrite® DP376 and Sancure® AU4010 (available from Lubrizol Advanced Materials, Inc., Ohio), and Hybridur® 570 (available from Air Products and Chemicals Inc., Pennsylvania).

The first crosslinked polymeric networks can be present in the coating composition in a variety of amounts. The first crosslinked polymeric networks can collectively represent from about 5 wt % to about 80 wt % of the total weight of the image-receiving layer. In another example, the first crosslinked polymeric networks can collectively represent from about 7 wt % to about 40 wt % of the total weight of the image-receiving layer.

In some examples, the second polymeric network is a polymeric aziridine polymer, also called polymeric aziridine or poly-aziridine.

In some examples, the polymeric aziridine crosslinker compound is selected from the group consisting of branched organic backbones with several pendant, chemically bound ethylene or propylene imine groups attached. In some other examples, the polyaziridine compound is selected from the group consisting of N-aminoethyl-N-aziridilethylamine, N,N-bis-2-aminopropyl-N-aziridilethylamine, N-3,6,9-triazanonylaziridine, the bis and tris aziridines of di and tri acrylates of alkoxylated polyols, the trisaziridine of the tri-acrylate of the adduct of glycerine and propylene oxide; the trisaziridine of the tri-acrylate of the adduct of trimethylolpropane and ethylene oxide and the trisaziridine of the tri-acrylate of the adduct of pentaerythritol and propylene oxide.

In some examples, the weight average molecular weight of the polymeric aziridine crosslinkers is greater than 1,000 Daltons (g/mol). In some other examples, the weight average molecular weight of the polymeric aziridine crosslinkers is greater than 2,000 Daltons (g/mol) (as measured by gel permeation chromatography).

The second polymeric network, present in the coating composition forming the image-receiving coating (120) is a network of polymeric aziridine, may be selected from following aziridine polymers such as, but not limited to, structure: I, II, III and IV.

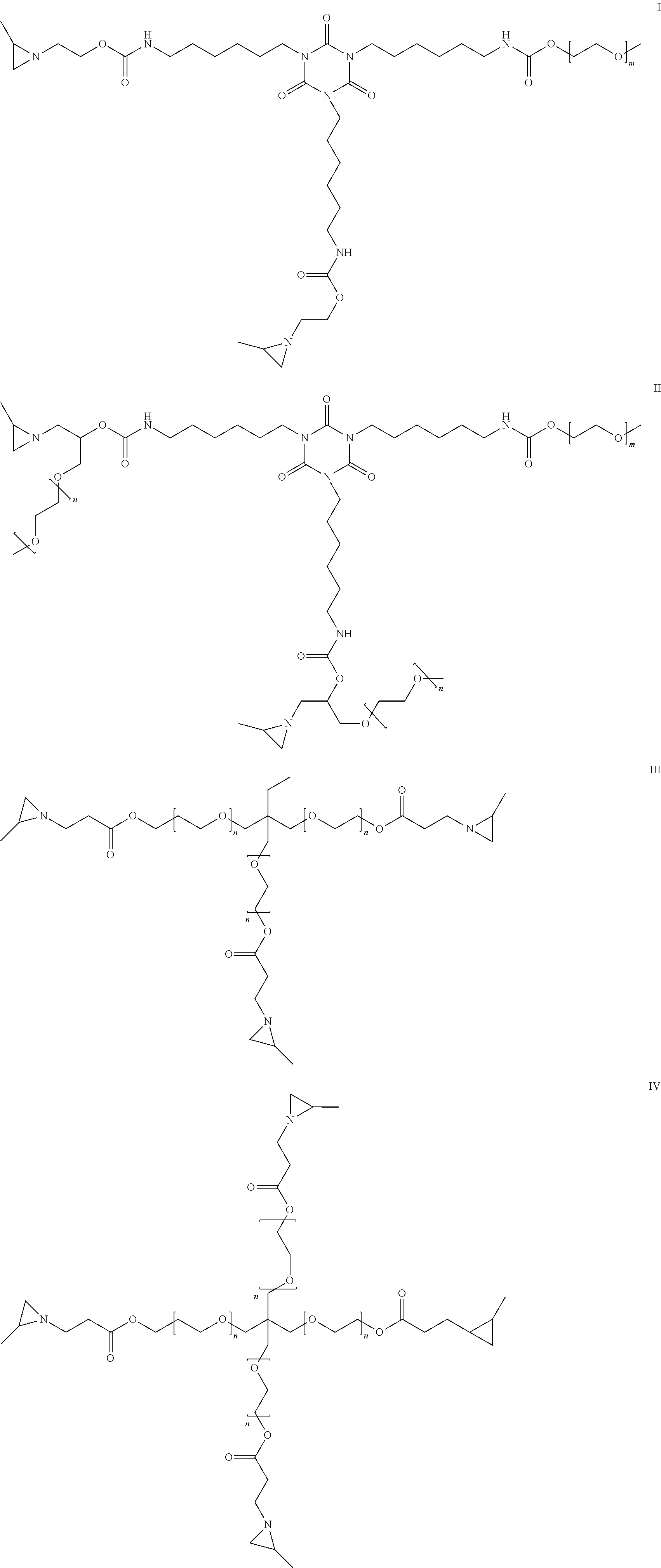

Wherein, m and n represent any integers greater than 8 to make the whole molecular weight over 1000. Some of chemical in the structures indicated above is commercially available. For example, the Polyaziridine with polymer structure indicated I can be found from supplier DSM under the trade name of NeoAdd® PAX 523, and thus is used as the example in the current disclosure.

In some other examples, the second polymeric network present in the coating composition is a network of polymeric aziridine selected from the structure: I, II, III or IV identified above. In yet some other example, the second polymeric network present in the coating composition forming the image-receiving coating (120) can be a polymeric network is created by using cross-linkable polymeric aziridine as shown in the structure I-IV above. Further it can also be selected from polyaziridine with multiple polymer chain as shown below:

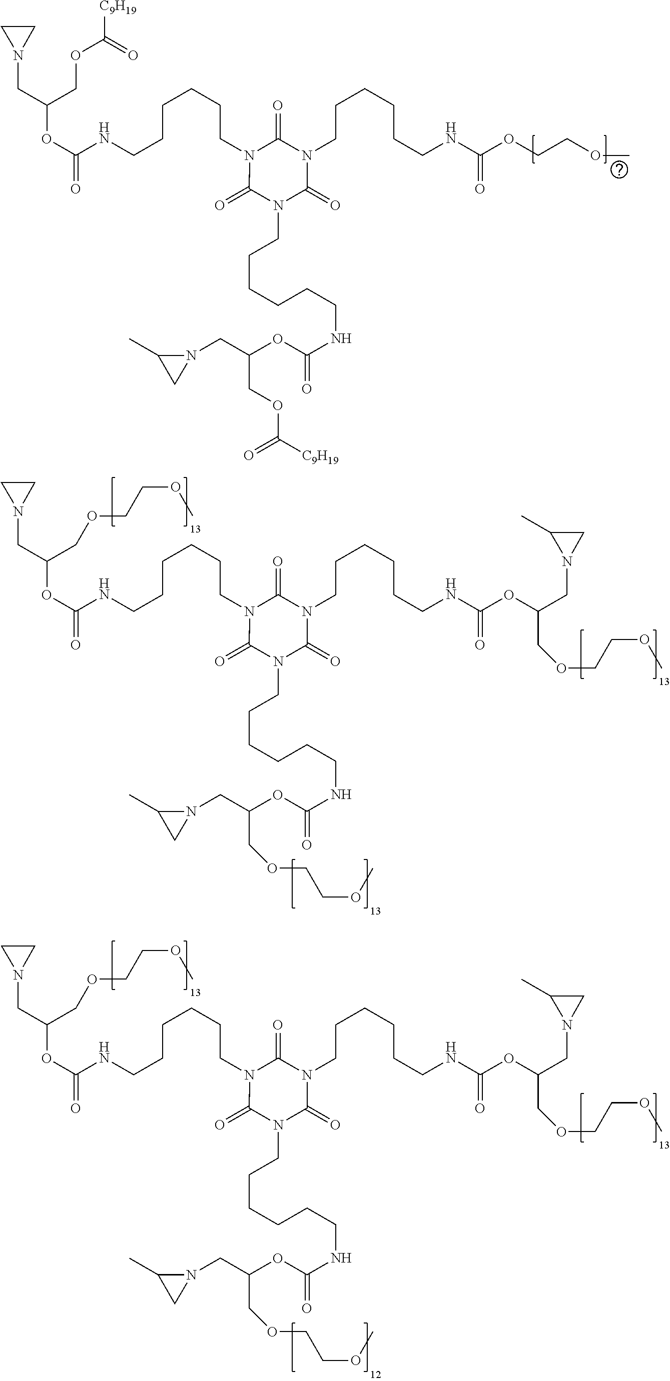

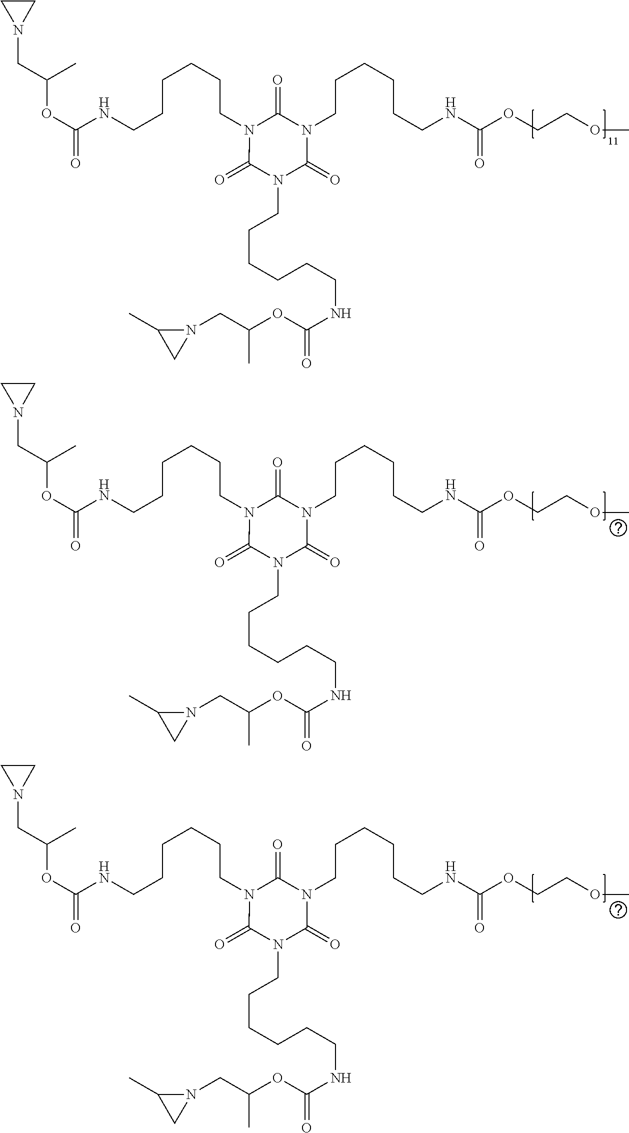

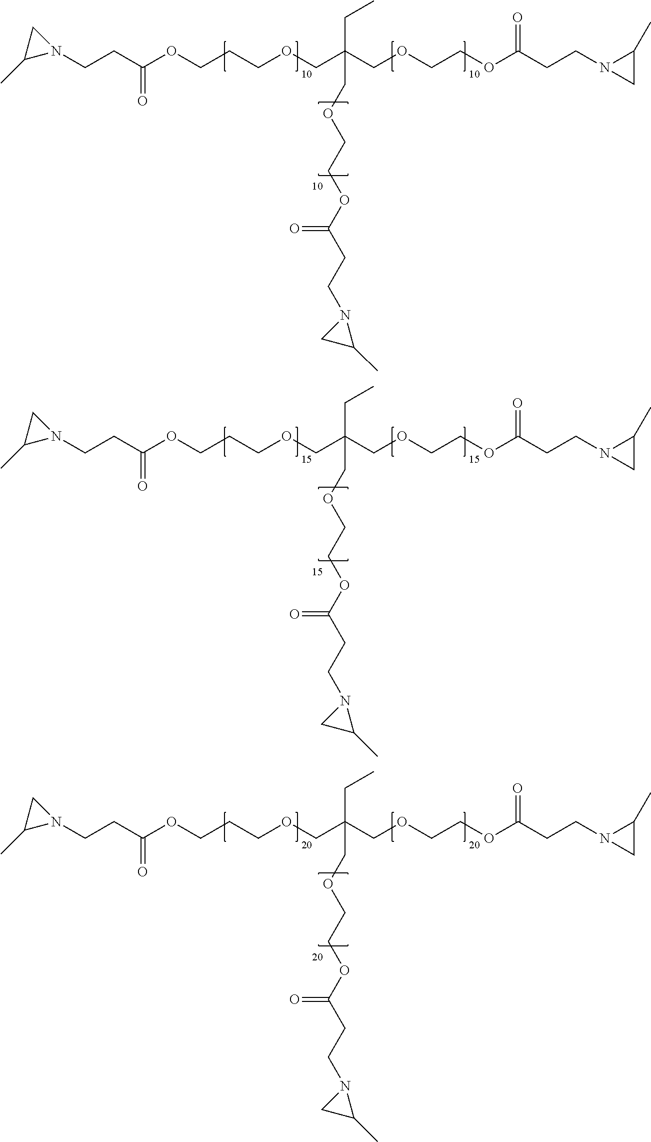

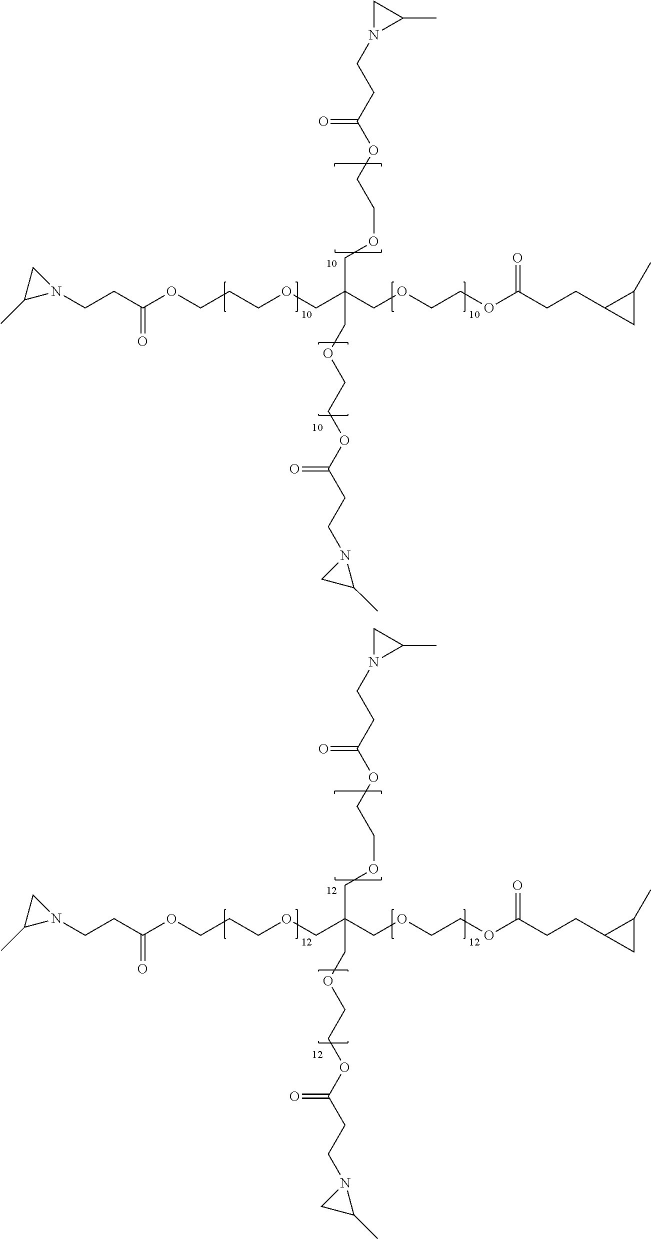

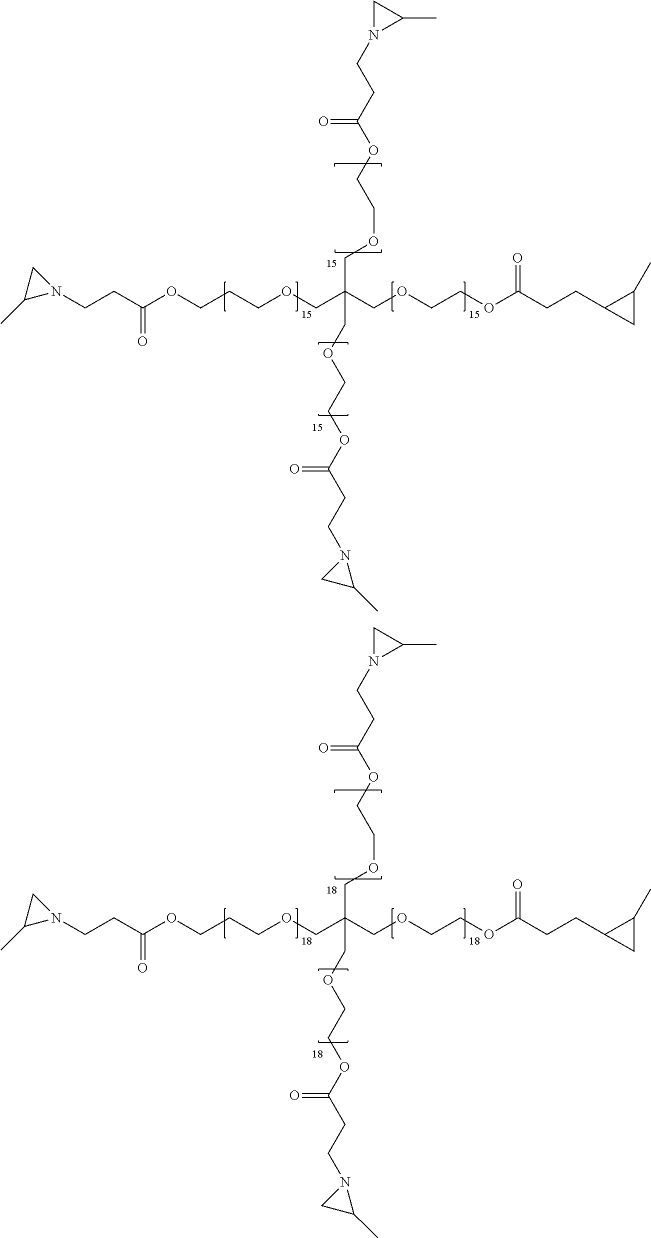

The second crosslinked polymeric networks can be present in the coating composition in a variety of amounts. The second crosslinked polymeric networks can collectively represent from about 0.5 wt % to about 40 wt % of the total weight of the image-receiving layer. In another example, the second crosslinked polymeric networks can collectively represent from about 0.8 wt % to about 20 wt % of the total weight of the image-receiving layer. In yet another example, the second crosslinked polymeric networks can collectively represent from about 1 wt % to about 10 wt % of the total weight of the image-receiving layer.

Without being linked by any theory, it is believed that, when the first polymeric network (polyurethane network, below also called resin) interacts with the second polymeric network (polymer aziridines) as illustrated in (V); the cross-linking reaction happens to form an inter-connected polymer network (VI), that might greatly increase the durability of the printed image.

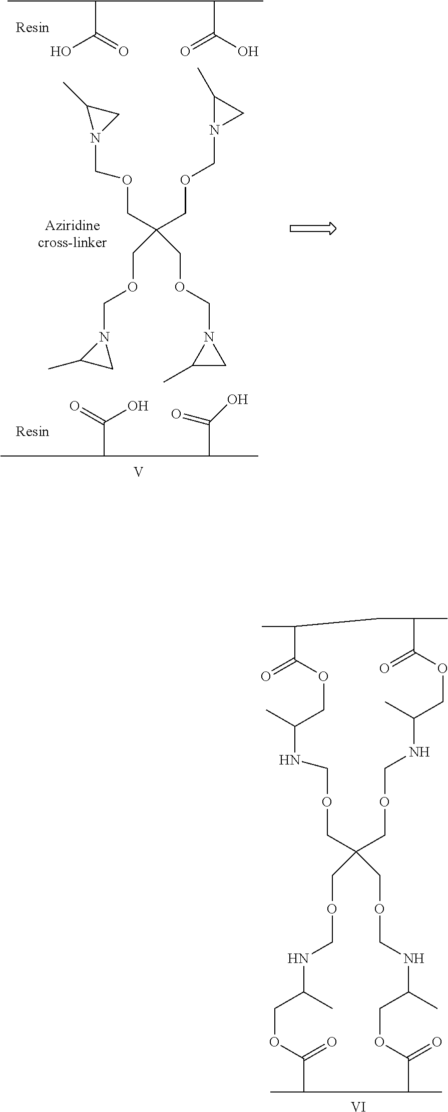

The coating layer composition (120) includes water as liquid vehicle for the polymeric network. The amount of water present in the coating composition is comprised between 20 wt % and 95 wt % of the total weight of the image-receiving layer.

The coating layer (120) may also include inorganic pigment particles and/or mixture inorganic particles. In one example, inorganic pigment particles and/or mixture inorganic particles can be particulate filler such as clay or calcium carbonate particles. In one example, inorganic pigment particles and/or mixture inorganic particles can be particulate filler can be ground calcium carbonate (GCC) or precipitated calcium carbonate (PCC). The clay particles and calcium carbonated particles of the various types described above, can be co-dispersed in the coating layer with other particulate fillers. The dispersion of the particles or mixture of the particles is compatible with the reactive crosslinking agents, meaning thus that there is no precipitation when mixing.

Other particulate fillers that can be used in addition to the calcium carbonate particles include inorganic fillers which can generate micro-porous structure to improved ink absorbing. Examples include fumed silica and silica gels, as well as certain structured pigments. Structured pigments include those particles which have been prepared specifically to create a micro-porous structure. Examples of these structured pigments include calcine clays or porous clays that are reaction products of clay with colloidal silica. Other inorganic particles such as particles of titanium dioxide (TiO2), silicon dioxide (SiO2), aluminum trihydroxide (ATH), calcium carbonate (CaCO3), or zirconium oxide (ZrO2) can be present, or these compounds can be present in forms that are inter-calcined into the structured clay. In one example, the inorganic pigment particles may be substantially non-porous mineral particles that have a special morphology that can produce a porous coating structure when solidified into a coating layer.

The coating layer composition (120) can include at least one type of particulate filler, or a mixture of different types particulate fillers. There is no specific limitation in selecting chemistry of particulate fillers, as long as these fillers have no chemical reactions in the solution of image receiving coating mixture before coating, where the pH of mixture is normally ranged between 4.5 to 6.5. The particulate fillers can be selected from, for example, kaolin, Kailin clays, barium sulfate, titanium dioxide, zinc oxide, zinc sulfide, satin white, aluminum silicate, diatomite, calcium silicate, magnesium silicate, synthetic amorphous silica, colloidal silica, colloidal alumina, pseudo-boehmite, aluminum hydroxide, alumina, lithopone, zeolite, and various combinations. In one example, particulate fillers are selected from the group consisting of silica, clay, kaolin, talc, titanium dioxide, and zeolites. In another example, the filler particles used are in a dry-powder form or in a form of an aqueous suspension referred as slurry with cationic charged dispersion agent since most anionic charged dispersing agent will be crashed by reactive cross-linking agent described above. When present, the amount of inorganic pigment particles and/or mixture inorganic particles the coating composition can range from about 1 wt % to about 95 wt % of the total weight of the image-receiving layer. In another example, the amount of inorganic pigment particles and/or mixture inorganic particles the coating composition can range from about 5 wt % to about 80 wt % of the total weight of the image-receiving layer.

The ink-receiving layer may also include other coating additives such as surfactants, rheology modifiers, defoamers, optical brighteners, biocides, pH controlling agents, dyes, and other additives for further enhancing the properties of the coating. The total amount of optional coating additives may be in the range of 0 to 10 wt % based on the total amount of ingredients. Among these additives, rheology modifier or rheology control agent is useful for addressing runnability issues. Suitable rheology control agents include polycarboxylate-based compounds, polycarboxylated-based alkaline swellable emulsions, or their derivatives. The rheology control agent is helpful for building up the viscosity at certain pH, either at low shear or under high shear, or both. In certain embodiments, a rheology control agent is added to maintain a relatively low viscosity under low shear, and to help build up the viscosity under high shear. It is desirable to provide a coating formulation that is not so viscous during the mixing, pumping and storage stages, but possesses an appropriate viscosity under high shear.

In some examples, the ink-receiving layer further includes a rheology control agent. The rheology control agent can be high molecular weight polymers, i.e. having a molecular weight ranging from about 300,000 to about 1,000,000. The rheology control agent can be copolymers of acrylates, copolymers with acrylate-based polyelectrolyte backbone, copolymers with polyester backbone, or copolymers with polyurethane based copolymer backbone. The rheology control agent can also be a copolymer with polyester backbone. In some examples, the rheology control agent is selected from the group consisting of copolymers of acrylates, copolymers with acrylate-based polyelectrolyte backbone, copolymers with polyester backbone, and copolymers with polyurethane based copolymer backbone.

Examples of such rheology control agent include Acusol® 810A, Acusol L® 830, Acusol® 835, Acusol® 842 (supplied by Rohm Haas/Dow Co); or Alcogum® L11, Alcogum® L12, Alcogum® L51, Alcogum® L31 and Alcogum® L52 (available from Akzo Nobel Co). Still another example of a suitable physical networking agent is hydroxyethyl cellulose. An example that is commercially available is Tylose® HS30000 (from SE Tylose GmbH & Co. KG). Other examples of rheology modifiers or rheology control agent that meet this requirement include, but are not limited to, Sterocoll® FS (from BASF), Cartocoat® RM 12 (from Clariant), Acrysol® TT-615 (from Rohm and Haas) and Acumer® 9300 (from Rohm and Haas). The amount of rheology modifier in the coating composition may be in the range of about 0.5 to about 15 wt % parts, more preferably, in the range of about 1 to about 5 wt % parts, based on total weight of the ingredients.

In some examples, the ink-receiving layer (120) is disposed on the image-side (101) of the fabric base substrate (110), at a coat-weight in the range of about 0.1 to about 40 gram per square meter (g/m2 or gsm), or in the range of about 1 gsm to about 20 gsm, or in the range of about 3 to about 15 gsm.

Method for Forming a Fabric Printable Medium

In some examples, according to the principles described herein, a method (200) for forming a fabric printable medium with a fabric base substrate (110) having, on its image side (101), an image receiving layer (120) is provided.

FIG. 3 is a flowchart illustrating a method of making the recording medium such as described herein. Such method encompasses providing (210) a base substrate (110) with an image-side (101) and a back-side (102); applying (220) a coating composition (120) on the image-side (101) of the fabric base substrate (110); and drying (230) the coating composition to remove water from the base substrate to leave an ink-receiving layer thereon. The coating composition comprises water and, at least, two polymeric networks with the first polymeric network being a polyurethane-based polymer and the second polymeric network being a reactive polyaziridine polymer. In some other examples, the encompasses providing a base substrate (110) with an image-side (101) and a back-side (102); applying (220) coating compositions (120) on the image-side (101) and on the a back-side (102) of the fabric substrate (110); and drying (230) the coating compositions to remove water and to leave an ink-receiving layer thereon in order to obtain a printable medium (100) with coating compositions applied on both side of the media. In some further examples, the base substrate (110) is a fabric base substrate (110).

The coating layer or ink-receiving layer (120) can be applied by any coating method. The coating methods may include, but are not limited to blade coating processes, rod coating processes, floating knife, knife on the roll, air-knife coating processes, curtain coating processes, slot coating processes, jet coating processing or any combination thereof. The layers can be dried by any suitable means, including, but not limited to, convection, conduction, infrared radiation, atmospheric exposure, or other known method.

Once applied to the image-side (101) of the substrate (110), the coating layer (120) can be calendered. The calendaring can be done either in room temperature or at an elevated temperature and/or pressure. In one example, the elevated temperature can range from 40° C. to 100° C. In one example, the calender pressure can range from about 100 psi to about 3,000 psi. A calendering process can then be used to achieve the desired gloss or surface smoothness. Calendering is the process of smoothing the surface of the paper by pressing it between nips formed in a pair of rollers. The rollers can be metal hard roll, and soft roll covered with a resilient cover, such as a polymer roll. The resilient-surface roll adapts itself to the contours of the surface of the substrate and presses the opposite side of substrate evenly against the smooth-surface press roll. Any of a number of calendering devices and methods can be used. The calendering device can be a separate super-calendering machine, an on-line calendaring unit, an off-line soft nip calendaring machine, or the like. In some examples, the calendering is carried out at a temperature ranging from about 50 to about 150° C. (metal roll surface temperature) and, in some other examples, from about 80 to about 110° C. The nip pressure can be any value between about 100 to about 500 KN/cm2.

Printing Method

Once the coating composition(s) is or are applied to the base substrate and appropriately dried, ink compositions can be applied by any processes onto the fabric printable medium. In some examples, the ink composition is applied to the printable medium via inkjet printing techniques. The printing method encompasses obtaining a printable medium, comprising a base substrate with an image-side and a back-side; an ink-receiving layer comprising water and, at least, two polymeric networks with the first polymeric network being a polyurethane-based polymer and the second polymeric network being a reactive polyaziridine polymer applied to the image-side of the fabric base substrate; and, then, applying an ink composition onto said fabric printable medium to form a printed image. Said printed image will have, for instance, enhanced image quality and image permanence. In some examples, when needed, the printed image can be dried using any drying device attached to a printer such as, for instance, an IR heater.

The ink composition may be deposited, established, or printed on the printable medium using any suitable printing device. In some examples, the ink composition is applied to the printable medium via inkjet printing techniques. The ink may be deposited, established, or printed on the medium via continuous inkjet printing or via drop-on-demand inkjet printing, which includes thermal inkjet printing and piezoelectric inkjet printing. Representative examples of printers used to print on the printable medium or wall covering medium, as defined herein, include, but are not limited to, HP DesignJet printers: L25500, L26500, and L65500; HP Scitex printers: LX600, LX800, LX850, and Turbojet® 8600 UV from Hewlett-Packard Company. Representative inkjet inks used by the above-listed printers include, but are not limited to, HP 791, HP 792, and HP Scitex TJ210. The printers may be used in a standard wallpaper profile with a production print mode or a normal print mode. The print mode may vary the ink application within a range of from about 50% to about 250% of each other.

Some examples of inkjet inks that may be deposited, established, or otherwise printed on the printable medium of the present disclosure include pigment-based inkjet inks, pigmented latex-based inkjet inks, and UV curable inkjet inks. In some examples, the ink composition is an inkjet ink composition that contains one or more colorants that impart the desired color to the printed message and a liquid vehicle. As used herein, “colorant” includes dyes, pigments, and/or other particulates that may be suspended or dissolved in an ink vehicle. The colorant can be present in the ink composition in an amount required to produce the desired contrast and readability. In some examples, the ink compositions include pigments as colorants. Pigments that can be used include self-dispersed pigments and non-self-dispersed pigments. Any pigment can be used; suitable pigments include black pigments, white pigments, cyan pigments, magenta pigments, yellow pigments, or the like. Pigments can be organic or inorganic particles as well known in the art. As used herein, “liquid vehicle” is defined to include any liquid composition that is used to carry colorants, including pigments, to a substrate. A wide variety of liquid vehicle components may be used and include, as examples, water or any kind of solvents.

In some other examples, the ink composition, applied to the print medium defined herein, is an ink composition containing latex components. Latex components are, for examples, polymeric latex particulates. The ink composition may contain polymeric latex particulates in an amount representing from about 0.5 wt % to about 15 wt % based on the total weight of the ink composition. The polymeric latex refers herein to a stable dispersion of polymeric micro-particles dispersed in the aqueous vehicle of the ink. The polymeric latex can be natural latex or synthetic latex. Synthetic latexes are usually produced by emulsion polymerization using a variety of initiators, surfactants and monomers. In various examples, the polymeric latex can be cationic, anionic, nonionic, or amphoteric polymeric latex. Monomers that are often used to make synthetic latexes include ethyl acrylate; ethyl methacrylate; benzyl acrylate; benzyl methacrylate; propyl acrylate; methyl methacrylate, propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxy-propyhiethyl-dimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; butyl acrylate; iso-butyl methacrylate; 2-ethylhexyl acrylate; 2-ethylhexyl methacrylate; isooctyl acrylate; and iso-octyl methacrylate. In some examples, the latexes are prepared by latex emulsion polymerization and have an average molecular weight ranging from about 10,000 Mw to about 5,000,000 Mw. The polymeric latex can be selected from the group consisting of acrylic polymers or copolymers, vinyl acetate polymers or copolymers, polyester polymers or copolymers, vinylidene chloride polymers or copolymers, butadiene polymers or copolymers, polystyrene polymers or copolymers, styrene-butadiene polymers or copolymers and acrylonitrile-butadiene polymers or copolymers. The latex components are on the form of a polymeric latex liquid suspension. Such polymeric latex liquid suspension can contain a liquid (such as water and/or other liquids) and polymeric latex particulates having a size ranging from about 20 nm to about 500 nm or ranging from about 100 nm to about 300 nm.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise. In describing and claiming the examples disclosed herein, the singular forms “a”, “an”, and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the latex polymers disclosed herein. This value can be determined, in one example, by dissolving or dispersing a known quantity of a material in organic solvent and then titrating with a solution of potassium hydroxide (KOH) of known concentration for measurement.

The term “(meth)acrylate,” “(meth)acrylic,” or “(meth)acrylic acid,” or the like refers to monomers, copolymerized monomers, etc., that can either be acrylate or methacrylate (or a combination of both), or acrylic acid or methacrylic acid (or a combination of both). This can be the case for either dispersant polymer for a pigment dispersion or for dispersed polymer binder particles that may include co-polymerized acrylate and/or methacrylate monomers. Also, in some examples, the terms “(meth)acrylate” and “(meth)acrylic” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

As used herein, “liquid vehicle” or “ink vehicle” refers to a liquid fluid in which colorant, such as pigments, can be dispersed and otherwise placed to form an ink composition. A wide variety of liquid vehicles may be used with the systems and methods of the present disclosure. Such liquid vehicles may include a mixture of a variety of different agents, including, water, organic co-solvents, surfactants, anti-kogation agents, buffers, biocides, sequestering agents, viscosity modifiers, surface-active agents, water, etc.

As used herein, “pigment” generally includes pigment colorants.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc. In some other examples, a range of 1 part to 20 parts should be interpreted to include not only the explicitly recited concentration limits of about 1 part to about 20 parts, but also to include individual concentrations such as 2 parts, 3 parts, 4 parts, etc. All parts are dry parts in unit weight, with the sum of all the coating components equal to 100 parts, unless otherwise indicated.

To further illustrate the present disclosure, an example is given herein. It is to be understood this example is provided for illustrative purposes and is not to be construed as limiting the scope of the present disclosure.

### EXAMPLES

The raw materials and chemical components used in the illustrating samples are listed in Table 1.

TABLE 1

| Ingredients | Nature of the ingredients | Supplier |
|---|---|---|
| Covercarb ® 85 | Calcium carbonate pigment fillers | Omya NA |
| Tegowet 510 | silicone-free wetting agent | Evonik, Inc. |
| | (Surfactant) | |
| Sancure ®AU4010 | Self-Crosslinking aliphatic | Lubrizol |
| | polyurethane-acrylic network | |
| Sancure ®2026 | Waterborne Urethane Polymer | Lubrizol |
| | (Non-reactive polymer) | |
| NeoAdd ®PAX 523 | Reactive polymeric aziridine | DSM |
| | network | |
| Byk-024 | Deformer | BYK USA, |
| | | Inc. |

### Example 1—Preparation of Printable Medium Samples

Different media were made using different base substrates and different coating compositions (Image receiving layer IR 1, IR2 or IR 3). The illustrating media samples (1, 2, 4 and 5) are printing media made in accordance with the principles described above. Sample 3 is comparative examples having the same supporting substrate as example 1. Detailed formulation and structure of these media samples are shown in Table 2 and Table 3.

The supporting substrate of example 1, 3 and 4 is a woven fabric having 100% count of polyester fibers, and having a yarn count of 75 by 72. The basis weight of the fabric supporting is 182 gsm. The supporting substrate for the media sample example 2 is a cellulose paper base with a basis weight of 154 gsm. The supporting base is saturated with about 10 gsm SBR polymeric resin on both surface to improve water resistance before coating with image receiving layer.

TABLE 2

| | | Image |
|---|---|---|
| | | receiving |
| Print media | | coating |
| Sample ID | Substrate | composition |
| Example 1 | 100% woven polyester fabric | IR1 |
| Example 2 | Cellulose paper | IR1 |
| Example 3 | 100% woven polyester fabric | IR3 |
| (comparative) | | |
| Example 4 | 100% woven polyester fabric | IR2 |
| Example 5 | Cellulose paper | IR2 |

TABLE 3
Image receiving layer composition (amount in dry parts)

| Ingredient | IR1 | IR2 | IR3 |
|---|---|---|---|
| Covercarb ® 85 | — | 100 | 100 |
| Tegowet ® 510 | 0.5 | 0.5 | 0.5 |
| Sancure ®AU4010 | 5 | 5 | 5 |
| Sancure ®2026 | 6 | 6 | 6 |
| NeoAdd ®PAX 523 | 1 | 1 | — |
| BYK ®-024 | — | 0.1 | 0.1 |

Different media samples (examples 1 to 5) are made using the different coating formulations. The coating composition are prepared by mixing the ingredients at room temperature in a mixing container with mediate shear speed (50-100 rpm) for 30 minutes. The mixtures are filtered with a 100-mesh screen and left for 1 hour to degas before use. The coating formulation are applied to the supporting substrate at a coat weight of 5 gsm over image receiving layer with examples 1, 3 and 4. The coating formulation are applied to the supporting substrate at a coat weight of 10 gsm over image receiving layer with examples 2 and 5 using a coater equipped with Mayer rod application station. Drying is accomplished in a box oven in 60° C.

### Example 2—Samples Performances

The same images are printed on the media samples 1, 2, 3, 4 and 5 using an HP Latex 360 printer equipped with HP 792 latex inks, using a six color process at 110° C. and at a speed of 100 square feet per hour (a 12 pass bidirectional color profile). An image is created on each media sample with an equal percentage of each of the six ink colors. The printed mediums are then evaluated for different performances: image durability and image quality, where image quality is evaluated using numeric measurement method. It involves printing standardized diagnostic images onto the said printing media, then numerically measuring gamut/color saturation and their black optical density (KOD) using spectrophotometer (such as the X-Rite i1/i0) and single-angle gloss-meter (such as the BYK Gloss-meter).

Gamut Measurement represents the amount of color space covered by the ink on the media sample (a measure of color richness). The gamut is measured on Macbeth® TD904 (Micro Precision Test Equipment, California) (A higher value indicates better color richness). The image gloss is evaluated using spectrophotometer (such as the X-Rite it/i0) and single-angle gloss-meter (such as the BYK Gloss-meter).

Image Durability is evaluated with rub resistance (dry rub) and scratch tests. Rub resistance testing is carried out using an abrasion scrub tester (per ASTM D4828 method): media are printed with small patches of all available colors (cyan, magenta, yellow, black, green, red, and blue). A weight of 250 g is loaded on the test header. The test tip is made of acrylic resin with crock cloth. The test cycle speed is 25 cm/min and 5 cycles are carried out for each sample at an 8-inch length for each cycle. The test probe is in dry (dry rub) mode.

Scratch test is performed by exposing the various samples to be tested to a 45-degree coin scratching under a normal force of 800 g. The test is done in a BYK Abrasion Tester (from BYK-Gardner USA, Columbus, MD) with a linear, back-and-forth action, attempting to scratch off the image-side of the samples (5 cycles).

The results of these tests are expressed in Table 4 below. Each testing item is given a rating score according to a 1 to 5 scale, wherein 1 means the worst performance and 5 represents the best performance. Scale: 1=Severe defects observed; 2=Many defects easily seen at 1 M distance; 3=acceptable level of defects; 4=Can have slight Defect at 1-meter viewing distance; 5=No Defect observed.

The data clearly demonstrate that the coated media of the present disclosure yield excellent image quality and durability whereas the control samples fail with durability under the same test condition.

TABLE 4

| | | | | Scratch resistance |
|---|---|---|---|---|
| | | | | (Cross-machine |
| Sample ID | Gamut | Black OD | Dry Rub | direction) |
| Example 1 | 602,000 | 1.5 | 5 | 4 |
| Example 2 | 738,000 | 1.8 | 5 | 5 |
| Example 3 | 604,000 | 1.6 | 1 | 2 |
| (comparative) | | | | |
| Example 4 | 616,000 | 1.7 | 4 | 5 |
| Example 5 | 764,000 | 1.9 | 5 | 5 |

1) A printable medium comprising a base substrate with an image-side and a back-side; a coating layer applied to, at least, the image-side of the base substrate, comprising water and, at least, two polymeric networks with the first polymeric network being a polyurethane-based polymer and the second polymeric network being a reactive polyaziridine polymer.

2) The printable medium of claim 1 wherein the coating layer is also applied to the back-side of the based substrate.

3) The printable medium of claim 1 wherein the base substrate is a textile base substrate.

4) The printable medium of claim 1 wherein, in the coating layer, the ratio of the first polymeric network to the second polymeric network is ranging from 10:0.3 to 10:5.

5) The printable medium of claim 1 wherein, in the coating layer, the first polymeric network is a mixture of self-crosslinkable polyurethane and non-reactive polyurethane polymers.

6) The printable medium of claim 1 wherein, in the coating layer, the first polymeric network is created by using vinyl-urethane hybrid copolymer or acrylic-urethane hybrid polymer.

7) The printable medium of claim 1 wherein, in the coating layer, the second polymeric network has an average molecular weight that is greater than 1,000 Daltons (g/mol).

8) The printable medium of claim 1 wherein, in the coating layer, the second polymeric network represents from about 0.5 wt % to about 40 wt % of the total weight of the coating layer.

9) The printable medium of claim 1 wherein the second polymeric network is selected from the group consisting of N-aminoethyl-N-aziridilethylamine, N,N-bis-2-aminopropyl-N-aziridilethylamine, N-3,6,9-triazanonylaziridine, the bis and tris aziridines of di and tri acrylates of alkoxylated polyols, the trisaziridine of the tri-acrylate of the adduct of glycerine and propylene oxide; the trisaziridine of the tri-acrylate of the adduct of trimethylolpropane and ethylene oxide and the trisaziridine of the tri-acrylate of the adduct of pentaerythritol and propylene oxide.

10) The printable medium of claim 1 wherein the coating layer further includes inorganic pigment particles and/or mixture inorganic particles.

11) The printable medium of claim 1 wherein the coating layer has a coat-weigh in the range of about 0.1 to about 40 gram per square meter (g/m2 or gsm).

12) A method for forming a printable medium comprising:
a. providing a base substrate, with an image-side and a back-side;
b. applying a coating composition on at least the image-side of the substrate, comprising water and, at least, two polymeric networks with the first polymeric network being a polyurethane-based polymer and the second polymeric network being a reactive polyaziridine polymer and;
c. drying the coating composition to remove water from the base substrate to leave an ink-receiving layer thereon.

13) The method for forming a printable medium of claim 12 wherein the base substrate is a textile base substrate.

14) A printing method comprising:
a. obtaining a printable medium comprising a base substrate with an image-side and a back-side; a coating layer applied to, at least, the image-side of the base substrate, comprising water and, at least, two polymeric networks with the first polymeric network being a polyurethane-based polymer and the second polymeric network being a reactive polyaziridine polymer;
b. and applying an ink composition onto said fabric printable medium to form a printed image.

15) The printing method of claim 14 wherein the ink composition is applied to the printable medium via inkjet printing techniques.
